(19) United States
(12) Patent Application Publication
(10) Pub. No.: US 2003/0188027 A1
(43) Pub. Date: Oct. 2, 2003

(54) System and method for a networked audio video control

(76) Inventors: Jeff Liu, Fremont, CA (US); Victor Dong, Fremont, CA (US)

Correspondence Address: Valley Oak Law, 5655 Silver Creek Valley Road, #106, San Jose, CA, 95138, US

(21) Appl. No.: 10/108,126

(22) Filed: Mar. 27, 2002

(51) Int. Cl. G06F 15/16

(52) U.S. Cl. 709/249; 709/246

(57) ABSTRACT

The invention illustrates a system and method of translating commands between a 1394 network and an IP network. The invention is configured to allow 1394 enabled devices to communicate with a variety of interfaces and devices through an IP network. The method for translating a command comprises: receiving the command via an IP network; translating the command into a 1394 message; and transmitting the 1394 message to a recipient 1394 device. The method may further parse the command into a unique device identifier portion and an AV/C command portion. The AV/C command portion would comprise the 1394 message, and the unique device identifier portion would correspond to a dynamic address for the 1394 message addressed to the recipient 1394 device. In addition to translating, the method of tracking a 1394 device comprising: receiving a status change message from the 1394 device; updating a unique identifier representing the 1394 device; updating a dynamic address of the 1394 device; and selectively broadcasting the unique identifier and the dynamic address through a TCP/IP message.

### FIELD OF THE INVENTION

The invention relates generally to the field of device control, and more particularly for controlling audio and/or video functions of a device.

### BACKGROUND OF THE INVENTION

Being able to communicate with audio/visual devices connected to a network allows users greater flexibility in viewing, storing and distributing audio/visual programming. Users are able to remotely record and view audio/visual content through a computer, video cassette recorder, digital video disc recorder, and digital video recorder which are connected to a network. In order for users to control these audio/visual devices, these devices typically need to be compatible with each other. Further, these audio/visual device also typically need to be networked to each other in order to communicate with each other. Additionally, the controlling device is typically also networked with the controlled device(s).

Many newer audio/visual devices are network compatible. One such popular network standard is IEEE1394 (1394) which is also known as iLink™ and Firewire™. Currently, many audio/video devices are 1394 compatible. For these audio/video devices to properly communicate with each other assuming a 1394 standard is utilized, the controlling device as well as the controlled device would need to be 1394 enabled and connected to a common 1394 bus.

Unfortunately, the 1394 standard has several limitations. A distance limitation restricts the distance allowed between the 1394 enabled device and the 1394 bus. For example, a 1394 enabled device cannot communicate with another 1394 enabled device several hundred feet away because of the distance limitation inherent in the 1394 standard.

Another limitation inherent with a 1394 network is that a system wide bus reset occurs whenever a 1394 enabled device is connected to the 1394 bus or disconnected from the 1394 bus. This bus reset becomes more disruptive as more and more devices are connected to the same 1394 bus. For example, if there are four 1394 enabled devices connected to the same 1394 bus and one particular 1394 enabled device is disconnected from the 1394 bus, then the 1394 bus is reset and the remaining three 1394 enabled devices are momentarily interrupted with the bus reset.

### SUMMARY OF THE INVENTION

The invention illustrates a system and method of translating commands between a 1394 network and an IP network. The invention is configured to allow 1394 enabled devices to communicate with a variety of interfaces and devices through an IP network. The method for translating a command comprises: receiving the command via an IP network; translating the command into a 1394 message; and transmitting the 1394 message to a recipient 1394 device. The method may further parse the command into a unique device identifier portion and an AV/C command portion. The AV/C command portion would comprise the 1394 message, and the unique device identifier portion would correspond to a dynamic address for the 1394 message addressed to the recipient 1394 device. In addition to translating, the method of tracking a 1394 device comprising: receiving a status change message from the 1394 device; updating a unique identifier representing the 1394 device; updating a dynamic address of the 1394 device; and selectively broadcasting the unique identifier and the dynamic address through a TCP/IP message.

Other aspects and advantages of the invention will become apparent from the following detailed description, taken in conjunction with the accompanying drawings, illustrated by way of example of the principles of the invention.

### BRIEF DESCRIPTION OF THE DRAWINGS

FIG. 1 illustrates one embodiment of a block diagram system overview according to the invention.

FIG. 2 illustrates one embodiment of a network AV/C module according to the invention.

FIG. 3A illustrates an exemplary GUID table according to the invention.

FIG. 3B illustrates an exemplary AV/C module command according to the invention.

FIG. 4 illustrates an exemplary process flow diagram of initiating a network AV/C module according to the invention.

FIG. 5 illustrates an exemplary process flow diagram of processing a status change within a network AV/C module according to the invention.

FIG. 6 illustrates an exemplary process flow diagram of processing a command within a network AV/C module according to the invention.

FIG. 7 illustrates an exemplary process flow diagram of processing an event notification within a network AV/C module according to the invention.

### DETAILED DESCRIPTION

Specific reference is made in detail to the embodiments of the invention, examples of which are illustrated in the accompanying drawings. While the invention is described in conjunction with the embodiments, it will be understood that the embodiments are not intended to limit the scope of the invention. The various embodiments are intended to illustrate the invention in different applications. Further, specific details are set forth in the embodiments for exemplary purposes and are not intended to limit the scope of the invention. In other instances, well-known methods, procedures, and components have not been described in detail as not to unnecessarily obscure aspects of the invention.

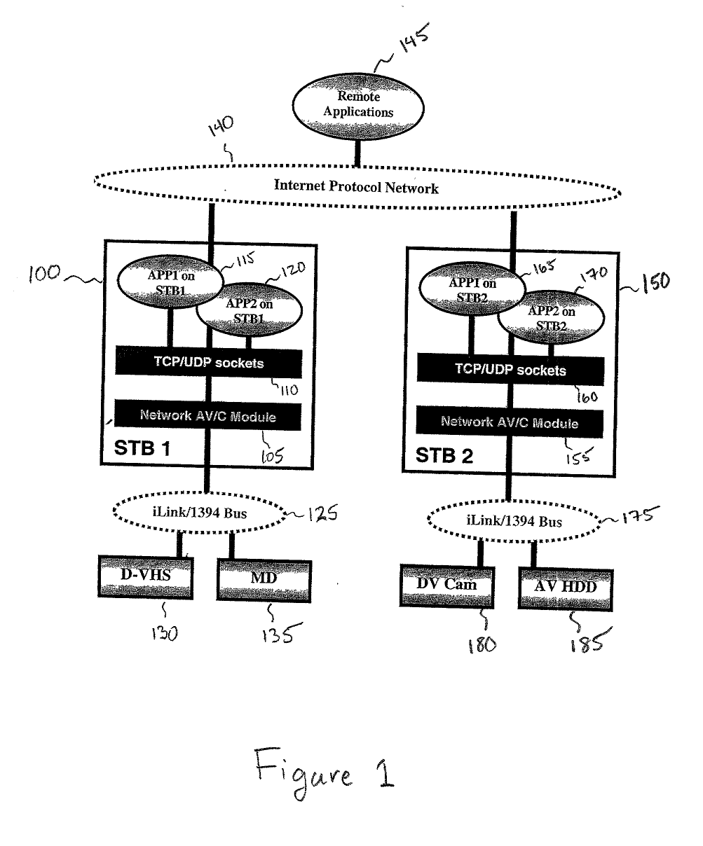

With reference to FIG. 1, a system is shown for controlling 1394 devices by issuing audio video control (AV/C) commands over a conventional network. In one embodiment, the conventional network is an Internet Protocol (IP) based network utilizing widely recognized TCP/IP standards.

The system in FIG. 1 is for illustrative purposes only. Fewer or additional elements may be utilized without departing from the scope of the invention. Further, elements may be combined or separated without departing from the scope of the invention. To illustrate the transmission of an AV/C command from one 1394 device to another 1394 device over the IP network, two set-top boxes are utilized to illustrate this capability; two set-top boxes are not required to implement the invention. The system includes a set-top box 100, a 1394 bus 125, a digital video cassette recorder (VCR) 130, a mini-disc (MD) 135, an IP network 140, a remote application 145, a set-top box 150, a 1394 bus 175, a digital video camera 180, and an audio/video hard drivel85.

The IP network 140 is coupled to the set-top box 100, the remote application 145, and the set-top box 150, such that the remote application 145 may communicate with the set-top boxes 100 and 140. Additionally, the set-top box 100 may communicate with the remote application 145 and the set-top box 140. Similarly, the set-top box 140 may communicate with the remote application 145 and the set-top box 100. When the remote application 145 and the set-top boxes 100 and 140 communicate with each other, they utilize a recognized standard such as TCP/IP. In other embodiments, various other standards or protocols may be utilized to effectuate communication between these devices.

The 1394 bus 125 is coupled to the set-top box 100, the digital VCR 130, and the MD 135, such that the set-top box 100, the digital VCR 130, and the MD 135 may communicate with each other through the 1394 bus 125. When the set-top box 100, the digital VCR 130, and the MD 135 communicate with each other through the 1394 bus 125, they utilize commands compatible with the 1394 standards. In other embodiments, various other standards or protocols may be utilized to effectuate communication between these devices.

Similarly, the 1394 bus 175 is coupled to the set-top box 150, the digital video camera 180, and the audio video hard drive 185, such that the set-top box 150, the digital video camera 180, and the audio video hard drive 185 may communicate with each other through the 1394 bus 175. When the set-top box 150, the digital video camera 180, and the audio video hard drive 185 communicate with each other through the 1394 bus 175, they utilize commands compatible with the 1394 standards. In other embodiments, various other standards or protocols may be utilized to effectuate communication between these devices.

The set-top box 100 includes a network AV/C module 105, TCP/UDP socket 110, an application 115, and an application 120. The network AV/C module 105 is coupled between the 1394 bus 125 and the TCP/UDP socket 110. The applications 115 and 120 are coupled to the TCP/UPD socket 110. The TCP/UPD socket 110 is coupled to the IP network 140. In other embodiments, additional or fewer applications are utilized within the set-top box.

Similarly, the set-top box 150 includes a network AV/C module 155, TCP/UDP socket 160, an application 165, and an application 170. The network AV/C module 155 is coupled between the 1394 bus 175 and the TCP/UDP socket 160. The applications 165 and 170 are coupled to the TCP/UPD socket 160. The TCP/UPD socket 160 is coupled to the IP network 140. In other embodiments, additional or fewer applications are utilized within the set-top box.

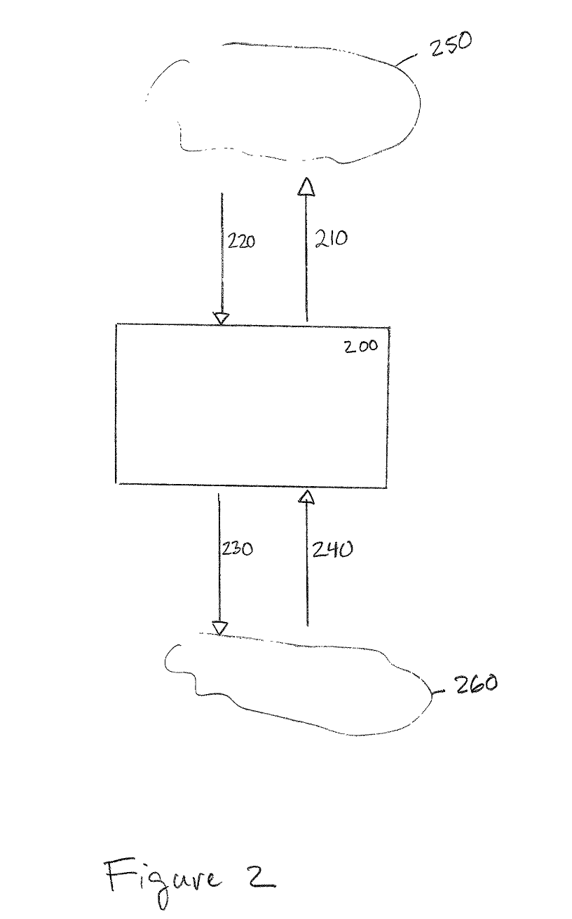

FIG. 2 illustrates an exemplary network AV/C module 200. Paths 210, 220, 230, and 240 merely illustrate an exemplary interface for the network AV/C module 200. The paths 210 and 220 couple the network AV/C module 200 with an IP network 250. The network AV/C module 200 interfaces with the IP network 250 via the paths 210 and 220 utilizing a communications standard such as TCP/IP. The paths 230 and 24 couple the network AV/C module 200 with a 1394 bus 260. Similarly, the network AV/C module 200 interfaces with the 1394 bus 260 via the paths 230 and 240 utilizing a communications standard such as the 1394 command sets.

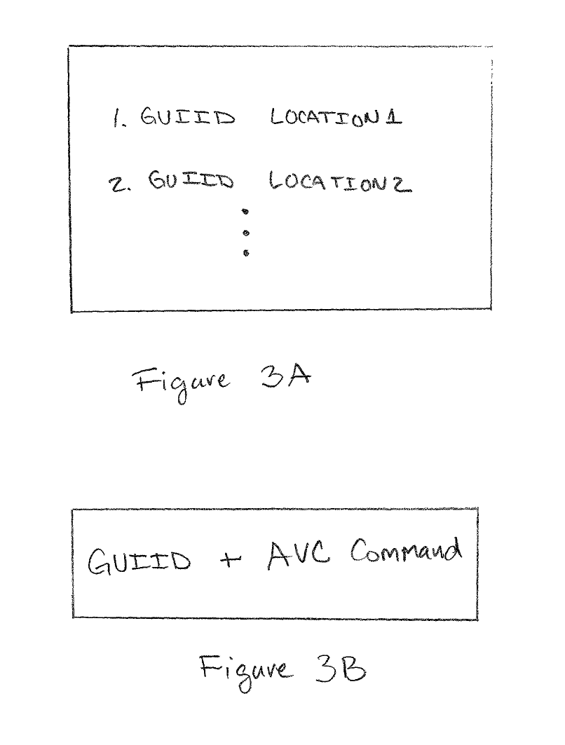

Commands from the IP network 250 pass through the path 220 and are received by the AV/C module 200. These commands received by the AV/C module 200 from the IP network 250 are configured according to a standard such as TCP/IP. These commands may contain information such as a globally unique identification (GUID) and AV/C Command as illustrated in FIG. 3B. The GUID uniquely identifies a 1394 enabled device connected to a 1394 bus such as the 1394 bus 260. However, the GUID may identify a 1394 enabled device which is either not currently connected to a 1394 bus or currently connected to a 1394 bus that is connected to different network AV/C module. The AV/C command provides a signal to a 1394 enabled device. In this case, the signal is addressed to the unique 1394 enabled device which is identified by the GUID. The signal may instruct the 1394 enabled device to start playing, start recording, stop all functions, fast forward, rewind, and the like. The AV/C commands are quite varied depending on the specific capabilities of the associated 1394 enabled device.

The network AV/C module 200 tracks 1394 enabled devices connected to the 1394 bus 260. Each of these 1394 devices have a unique GUID. The network AV/C module 200 maintains a list of all 1394 enabled devices connected to the 1394 bus 260 by listing their unique GUID and their respective location. An exemplary list is illustrated in FIG. 3B. Other 1394 enabled devices which are not connected to the specific 1394 bus 260 are not tracked by the specific network AV/C module 200.

After the network AV/C module 200 receives a command from the IP network 250, the network AV/C module 200 checks if the GUID identified in the command is associated with a 1394 enabled device connected to the AV/C module 200. The network AV/C module 200 may check a list similar to the one in FIG. 3B.

If the network AV/C module 200 determines that GUID in the command is associated with a 1394 enabled device connected to the AV/C module 200, then the network AV/C module 200 translates the command from the IP network 250 into an appropriate AV/C command conforming to 1394 standards and transmits this AV/C command to the location of the 1394 device via the path 230. The location of the 1394 device is tracked by the network AV/C module 200 and may be referred to as a dynamic address. The location is stored in a list similar to the one in FIG. 3A.

In one embodiment, if the network AV/C module 200 determines that GUID in the command is not associated with a 1394 enabled device connected to the AV/C module 200, then the network AV/C module 200 takes no action.

Through the path 240, 1394 enabled devices connected to the 1394 bus 160 may transmit AV/C commands to the network AV/C module 200. These AV/C commands may be status confirmations, connect signals, disconnect signals, functional instructions, and the like.

If the AV/C command through the path 240 changes the status and/or dynamic address of the particular 1394 enabled device, the network AV/C module 200 updates the tracking list similar to the one shown in FIG. 3A. If the AV/C command through the path 240 is directed to a different device other than a 1394 enable device connected to the 1394 bus 260, the network AV/C module 200 translates the AV/C command into a format suitable for transmission over the IP network 250 via the path 250.

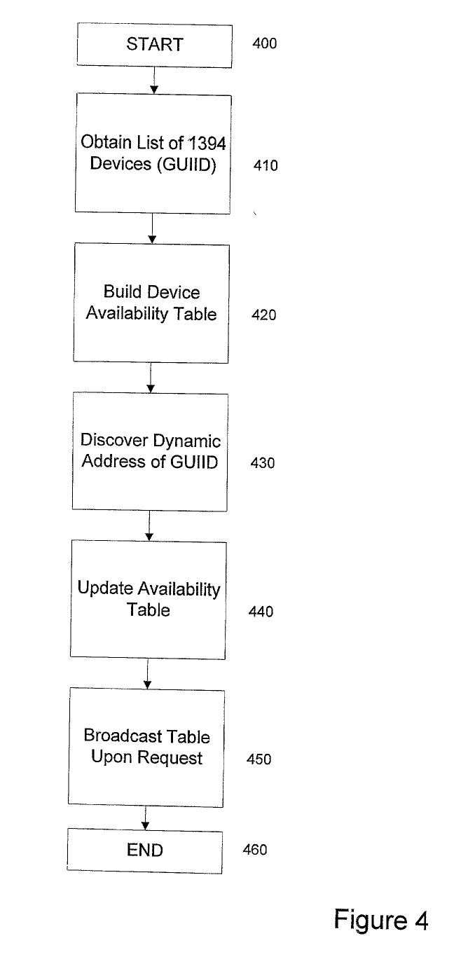

The operation of the system of FIG. 1 while initiating the network AV/C modules 105 and 155 is described with references to the flow diagram shown in FIG. 4. At Block 400, the process of initiating the network AV/C modules 105 and 155 begins. At Block 410, the network AV/C modules 105 and 155 obtain a list of 1394 devices by polling devices that are connected to the network busses 125 and 175, respectively. For example, the digital VCR 130 and the MD 135 would be discovered by the network AV/C module 105. In another example, the digital video camera 180 and the audio/video hard drive 185 are discovered by the network AV/C module 155.

At Block 420, a device availability table is built by each of the network AV/C modules 105 and 155. The device availability table includes the GUID of the device identified by the network AV/C modules 105 and 155. The device availability table may resemble the table in FIG. 3A. At Block 430, the dynamic addresses of the devices listed in the device availability table are discovered. At Block 440, the device availability table is updated with the dynamic addresses of the devices identified by the GUID. In Block 450, the device availability table is selectively broadcasted to other devices that request this information. For example, the set-top box 150 and the remote application 145 may register that they are interested in the device availability table from the set-top box 100. In this case, the network AV/C 105 distributes the device availability table to the set-top box 150 and the remote application 145. In one embodiment, the selective broadcast of the device availability table is performed via TCP/IP. In other embodiments, different transfer protocols may be utilized. In yet another embodiment, the device availability table may be broadcasted to other nodes which have registered to receive this information. In Block 460, the initiation of the network AV/C terminates.

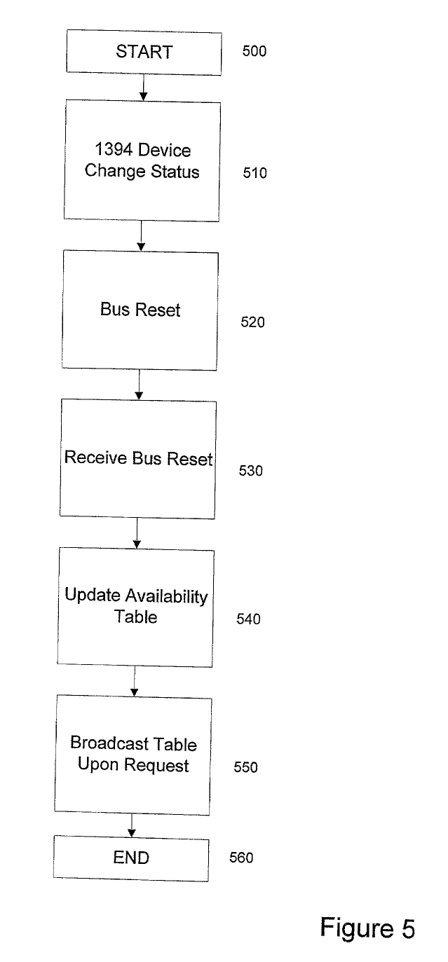

The operation of the system of FIG. 1 while updating the network AV/C modules 105 and 155 of a status change is described with references to the flow diagram shown in FIG. 5. At Block 500, the process of updating the device availability table within the network AV/C modules 105 and 155 begins. In Block 510, a 1394 enabled device changes status. A change in status includes a connection to a 1394 bus, disconnection to a 1394 bus, a connected device issues an autonomous bus reset without disconnecting from the bus, and the like. For example, the digital VCR 130, the MD 135, the digital video camera 180, and the A/V hard drive 185 being connected or removed from their respective 1394 busses would constitute a status change. In Block 520, a bus reset is performed on the appropriate 1394 bus. For example, if the digital VCR 130 or the MD 135 is connected or disconnected from the 1394 bus 125, a bus reset would be performed on the 1394 bus 125. Similarly, if the digital video camera 180 or the A/V hard drive 185 is connected or disconnected from the 1394 bus 175, a bus reset would be performed on the 1394 bus 175.

In Block 530, a bus reset is received by a network AV/C module. For example, if a bus reset is performed on the 1394 bus 125, the network AV/C module 105 receives the bus reset. Similarly, if a bus reset is performed on the 1394 bus 175, the network AV/C module 155 receives the bus reset. In Block 540, the device availability table is updated based on the bus reset. For example, the bus reset is performed based on a connection or disconnection of a 1394 device, and the device availability table is updated accordingly. In Block 550, the device availability table, which was updated in the Block 540, is selectively broadcasted to other devices that request this information. In Block 560, the update of the network AV/C terminates.

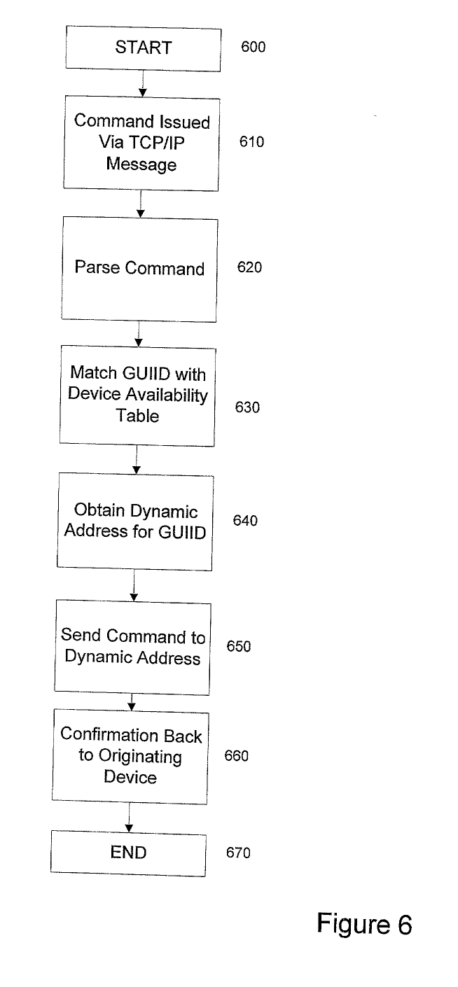

The operation of the system of FIG. 1 while the network AV/C modules 105 and 155 process a command is described with references to the flow diagram shown in FIG. 6. At Block 600, processing a command within the network AV/C modules 105 and 155 begins. At Block 610, a command is issued to a network AV/C module via a TCP/IP message. For example, the network AV/C module 105 may receive a command from the remote application 145 or the set-top box 150. The command from the set-top box 150 may originate from the application 165, the application 170, the digital video camera 180, or the AV hard drive 185. The command may include a play command, forward command, rewind command, stop command, record command, and the like. The particular command varies depending on the functionality of the device as the intended recipient of the command. The command may resemble the sample shown in FIG. 3B having a GUID component and the actual AV/C command.

In Block 620, the network AV/C module parses the command into the GUID component and the AV/C command. In Block 630, the network AV/C module matches the GUID from the command to the device availability table for the particular network AV/C module. For example, if the network AV/C module 105 parses the command, the network AV/C module 105 matches the GUID with the device availability table for the AV/C module 105. In Block 640, assuming that the GUID was matched to the device availability table in the Block 630, the dynamic address is accessed from the device availability table with the network AV/C module. In Block 650, the AV/C command, previously parsed in the Block 620, is sent by the network AV/C module to the dynamic address identified by the GUID. In Block 660, the device identified by the dynamic address sends a confirmation back to the originating device through the corresponding network AV/C module. In Block 670, the command processing within the network AV/C terminates.

For example, the AN hard drive 185 originates a “record” command addressed to the digital VCR 130. The network AV/C module 155 receives the “record” command through the 1394 bus; translates the “record” command into a TCP/IP message; and broadcasts this message over the IP network 140. [Block 610] The “record” command formatted is received by the network AV/C module 105 and is parsed into the GUID component (digital VCR 130) and the AV/C command (record command). [Block 620] The network AV/C module 105 matches the GUID component with the device availability table. The network AV/C module 105 finds that the GUID component matches the digital VCR 130. [Block 630] The network AV/C module 105 locates the dynamic address for the digital VCR 130 from the device availability table. [Block 640] The network AV/C module 105 sends the AV/C command (record command) to the dynamic address for the digital VCR 130. [Block 650] The digital VCR 130 sends a confirmation back to the A/V hard drive 185 by sending a 1394 message back to the network AV/C module 105. The network AV/C module 105 converts the 1394 message into a TCP/IP message addressed to the AN hard drive with a “confirmation” command. The network AV/C module 105 sends this TCP/IP message through the IP network 140. [Block 660] By sending this “confirmation” command through the IP network 140, the network AV/C module 105 sends a command as described by Block 610.

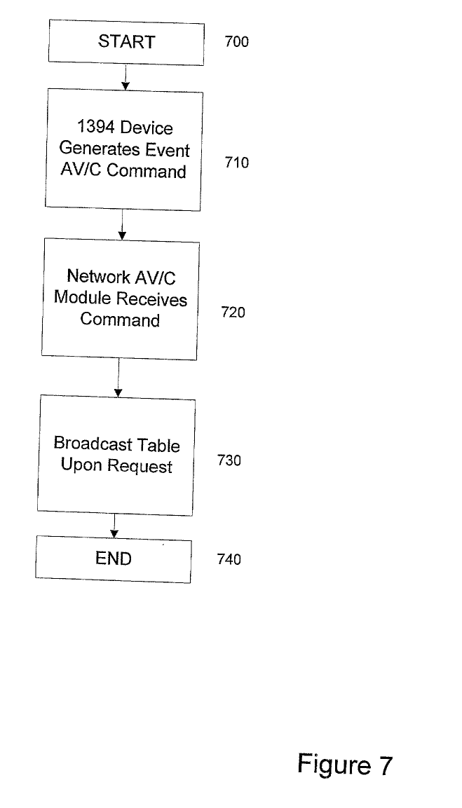

The operation of the system of FIG. 1 while the network AV/C modules 105 and 155 process an event notification is described with references to the flow diagram shown in FIG. 7. At Block 700, processing an event notification within the network AV/C modules 105 and 155 begins. In Block 710, a 1394 enabled device generates an event notification. An event notification includes an end of tape message, a user initiated function, a battery warning, and the like. The user initiated function includes stop command, rewind command, record command, forward command, and the like.

In Block 720, a network AV/C module receives the event notification. For example, if the tape inside the digital video camera 180 runs out of tape, the digital video camera 180 generates an “end of tape” event notification. The network AV/C module 155 receives this “end of tape” event notification. In Block 730, a network AV/C module formats the event notification into a TCP/IP message and selectively broadcasts the notification to devices which are interested. In another embodiment the “end of tape” event notification is addressed to the MD 135. Accordingly, the event notification is addressed to the GUID corresponding to the MD 135. In Block 740, the event notification processing within the network AV/C terminates.

The flow diagrams as depicted in FIGS. 4, 5, 6, and 7 are merely one embodiment of the invention. The blocks may be performed in a different sequence without departing from the spirit of the invention. Further, blocks may be deleted, added or combined without departing from the spirit of the invention.

The foregoing descriptions of specific embodiments of the invention have been presented for purposes of illustration and description. For example, the invention is described within the context of set-top boxes as merely embodiments of the invention. The invention may be applied to a variety of other devices.

They are not intended to be exhaustive or to limit the invention to the precise embodiments disclosed, and naturally many modifications and variations are possible in light of the above teaching. The embodiments were chosen and described in order to explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

1. A method of translating a command comprising:
a. receiving the command via an IP network;
b. translating the command into a 1394 message; and
c. transmitting the 1394 message to a recipient 1394 device.

2. The method according to claim 1 wherein the command via the IP network is a TCP/IP message.

3. The method according to claim 1 further comprising parsing the command into GUID and AV/C command.

4. The method according to claim 3 wherein the 1394 message contains the AV/C command.

5. The method according to claim 3 further comprising matching the GUID of the command to available 1394 devices.

6. The method according to claim 1 further comprising sending the 1394 message to the dynamic address of the recipient 1394 device.

7. A method of translating a command comprising:
a. receiving the command from a 1394 device as a 1394 message;
b. translating the 1394 message into a TCP/IP message; and
c. transmitting the TCP/IP message to a recipient device.

8. The method according to claim 7 further comprising formatting the TCP/IP message to contain a GUID and an AV/C command.

9. A method of tracking a 1394 device comprising:
a. receiving a status change message from the 1394 device;
b. updating a unique identifier representing the 1394 device;
c. updating a dynamic address of the 1394 device; and
d. selectively broadcasting the unique identifier and the dynamic address through a TCP/IP message.

10. The method according to claim 9 wherein the status change represents a new connection for the 1394 device.

11. The method according to claim 9 wherein the status change represents a disconnection for the 1394 device.

12. The method according to claim 9 wherein the unique identifier is a GUID.

13. The method according to claim 9 wherein selectively broadcasting is based on a registered device.

14. The method according to claim 9 further comprising building a device availability table having the unique identifier correspond with the dynamic address.

15. A system for translating a command comprising:
a. an internet protocol network for transporting an internet protocol message;
b. a 1394 bus for transporting a 1394 message; and
c. a network AV/C module coupled between the internet protocol network and the 1394 bus, wherein the network AV/C module is configured to translate the internet protocol message into the 1394 message.

16. The system according to claim 15 further comprising a 1394 device connected to the 1394 bus.

17. The system according to claim 16 wherein the network AV/C module further comprises a device availability table for tracking the 1394 device.

18. The system according to claim 15 wherein the internet protocol message contains a GUID and an AV/C command.

19. The system according to claim 15 wherein the 1394 message contains an AV/C command and the 1394 message is transmitted to a dynamic address corresponding to a GUID.

20. A computer-readable medium having computer executable instructions for performing a method comprising:
a. receiving the command via an IP network;
b. translating the command into a 1394 message; and
c. transmitting the 1394 message to a recipient 1394 device.
